(19) United States
(12) Patent Application Publication
(10) Pub. No.: US 2010/0033502 A1
(43) Pub. Date: Feb. 11, 2010

(54) IMAGE PROCESSING APPARATUS FOR SUPERIMPOSING WINDOWS DISPLAYING VIDEO DATA HAVING DIFFERENT FRAME RATES

(75) Inventors: Christophe Comps, Cugnaux (FR); Sylvain Gavelle, Toulouse (FR); Vianney Rancurel, Toulouse (FR)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 12/445,021

(22) PCT Filed: Oct. 13, 2006
(86) PCT No.: PCT/IB06/54685

§ 371 Date: Apr. 9, 2009

(51) Int. Cl. G09G 5/377; G09G 5/36

(52) U.S. Cl. 345/634; 345/547

(57) ABSTRACT

A method of transferring image data to a composite memory space comprises including masking data defining a reserved output area in a first memory space and containing first time-varying data having a first frame rate associated therewith. Second time-varying image data is stored in a second memory space and is associated with a second frame rate. At least part of the first image data is transferred to the composite memory space and at least part of the second image data is transferred to the composite memory. The mask data is used to provide the at least part of the second image data such that, when output, the at least part of the second image data occupies the reserved output area.

### FIELD OF THE INVENTION

This invention relates to a method of transferring image data of the type, for example, represented by a display device and corresponding to time-varying images of different frame rates. This invention also relates to an image processing apparatus of the type, for example, that transfers image data for representation by a display device and corresponding to time-varying images of different frame rates.

### BACKGROUND OF THE INVENTION

In the field of computing devices, for example portable electronic equipment, it is known to provide a Graphical User Interface (GUI) so that a user can be provided with output by the portable electronic equipment. The GUI can be an application, for example an application known as “QT” that runs on a Linux™ operating system, or the GUI can be an integral part of an operating system, for example the Windows™ operating system produced by Microsoft Corporation.

In some circumstances, the GUI has to be able to display multiple windows, a first window supporting display of first image data that refreshes at a first frame rate and a second window supporting display of second image data that refreshes at a second frame rate. Additionally, it is sometimes necessary to display additional image data in another window at the second frame rate or indeed a different frame rate. Each window can constitute a plane of image data, the plane being a collection of all necessary graphical elements for display at a specific visual level, for example a background, a foreground, or one of a number of intermediate levels therebetween. Currently, GUIs manage display of, for example, video data generated by a dedicated application such as a media player, on a pixel-by-pixel basis. However, as the number of planes of image data increases, current GUIs become increasingly incapable of performing overlays of the planes in real time using software. Known GUIs that can support multiple overlays in real time expend an extensive number of Million Instructions Per Second (MIPS) with associated power consumption. This is undesirable for portable, battery-powered, electronic equipment.

Alternatively, additional hardware is provided to achieve the overlay and such a solution is not always suitable for all image display scenarios.

One known technique employs to so-called “plane buffers” and a presentation frame buffer for storing resultant image data obtained by combination of the contents of the two plane buffers. A first plane buffer comprises a number of windows including a window that supports time-varying image data, for example, interposed between foreground and background windows. The window that supports the time-varying image data has a peripheral border characteristic of a window and a bordered area in which the time-varying image data is to be represented. The time-varying image data is stored in a second plane buffer and superimposed on the bordered area by hardware by copying the content of the first plane buffer to the resultant plane buffer and copying the content of the second plane buffer to the presentation plane buffer to achieve combination of the contents of the two plane buffers. However, due to the crude nature of this combination, the time-varying image data does not reside correctly relative to the order of the background and foreground windows and so can overlie some foreground windows resulting in the foreground windows being incorrectly obscured by the time-varying image data. Additionally, where one of the foreground windows refreshes at a similar frame rate to that of the time-varying image date, competition for “foreground attention” will occur, resulting in flickering as observed by a user of the portable electronic equipment.

Another technique employs three plane buffers. A pair of plane buffers are employed in which a first plane buffer comprises, for example, data corresponding to a number of windows constituting a background part of a GUI, and a second plane buffer is used to store frames of time-varying image data. The contents of the first and second plane buffers are combined in the conventional manner described above by hardware and the combined image data stored in a resultant plane buffer. A third plane buffer is used to store windows and other image data constituting a foreground part of the GUI. To achieve a complete combination of image data, the content of the third plane buffer is transferred to the resultant plane buffer in order that the image data of the third plane buffer overlies the content of resultant plane buffer where appropriate.

However, the above techniques represent imperfect or partial solutions to the problem of correct representation of time-varying image data by a GUI. In this respect, due to hardware constraints, many implementations are limited to handling image data in two planes, i.e. a foreground plane and a background plane. Where this limitation does not exist, additional programming of the GUI is required in order to support splitting of the GUI into a foreground part and a background part and also manipulation of associated frame buffers. When the hardware of the electronic equipment is designed to support multiple operating systems, support for foreground/background parts of the GUI is impractical.

Furthermore, many GUIs do not support multiple levels of video planes. Hence, representation of additional, distinct, time-varying image data by the GUI is not always possible. In this respect, for each additional video plane, a new plane buffer has to be provided and supported by the GUI, resulting in consumption of valuable memory resources. Furthermore, use of such techniques to support multiple video planes is not implemented by all display controller types.

### STATEMENT OF INVENTION

According to the present invention, there is provided a method of transferring image data and an image processing apparatus as set forth in the appended claims.

### BRIEF DESCRIPTION OF THE DRAWINGS

At least one embodiment of the invention will now be described, by way of example only, with reference to the accompanying drawings, in which:

FIG. 1 is a schematic diagram of an electronic apparatus comprising hardware to support an embodiment of the invention; and

FIG. 2 is a flow diagram of a method of transferring image data constituting the embodiment of the invention.

### DESCRIPTION OF PREFERRED EMBODIMENTS

Throughout the following description identical reference numerals will be used to identify like parts.

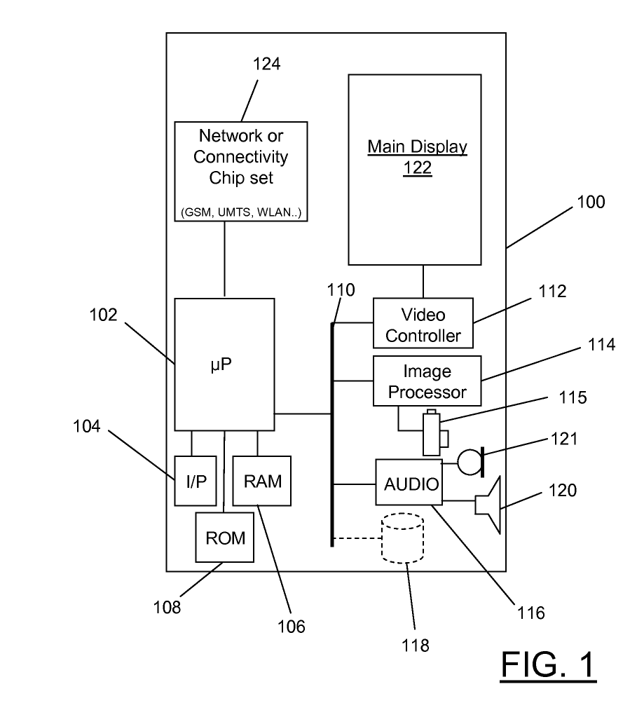

Referring to FIG. 1, a portable computing device, for example a Personal Digital Assistant (PDA) device with a wireless data communication capability, such as a so-called smartphone 100, constitutes a combination of a computer and a telecommunications handset. Consequently, the smartphone 100 comprises a processing resource, for example a processor 102 coupled to one or more input device 104, such as a keypad and/or a touch-screen input device. The processor 102 is also coupled to a volatile storage device, for example a Random Access Memory (RAM) 106, and a non-volatile storage device, for example a Read Only Memory (ROM) 108.

A data bus 110 is also provided and coupled to the processor 102, the data bus 110 also being coupled to a video controller 112, an image processor 114, an audio processor 116, and a plug-in storage module, such as a flash memory storage unit 118.

A digital camera unit 115 is coupled to the image processor 114, and a loudspeaker 120 and a microphone 121 are coupled to the audio processor 116. An off-chip device, in this example a Liquid Crystal Display (LCD) panel 122, is coupled to the video controller 112.

In order to support wireless communications services, for example a cellular telecommunications service, such as a Universal Mobile Telecommunications System (UMTS) service, a Radio Frequency (RF) chipset 124 is coupled to the processor 102, the RF chipset 124 also being coupled to an antenna (not shown).

The above-described hardware constitutes a hardware platform and the skilled person will understand that one or more of the processor 102, the RAM 106, the video controller 112, the image processor 114 and/or the audio processor 116 can be manufactured as one or more Integrated Circuit (IC), for example an application processor or a baseband processor (not shown), such as the Argon LV processor or the i.MX31 processor available from Freescale Semiconductor, Inc. In the present example, the i.MX31 processor is used.

The processor 102 of the i.MX31 processor is an Advanced Risc Machines (ARM) design processor and the video controller 112 and image processor 114 collectively constitute the Image Processing Unit (IPU) of the i.MX31 processor. An operating system is, of course, run on the hardware of the smartphone 100 and, in this example, the operating system is Linux.

Whilst the above example of the portable computing device has been described in the context of the smartphone 100, the skilled person will appreciate that other computing devices can be employed. Further, for the sake of the conciseness and clarity of description, only parts of the smartphone 100 necessary for understanding the embodiments herein are described; the skilled person will, however, appreciate that other technical details are associated with the smartphone 100.

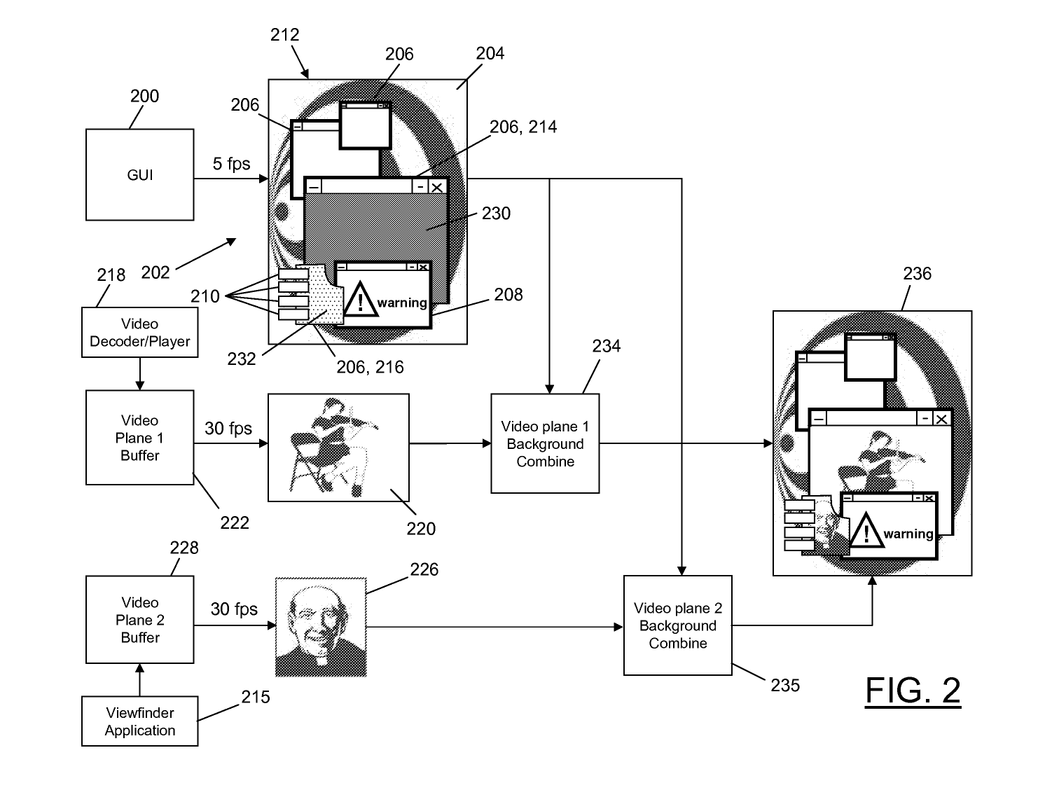

In operation (FIG. 2), a GUI software 200, for example QT for Linux, provides a presentation plane 202 comprising a background or “desktop” 204, background objects, in this example a number of background windows 206, a first intermediate object, in this example a first intermediate window 208 and a foreground object 210 relating to the operating system; the purpose of the foreground object 210 is irrelevant for the sake of this description.

The presentation plane 202 is stored in a user-interface frame buffer 212 constituting a first memory space, and is updated at a frame rate of, in this example, 5 frames per second (fps). The presentation plane 202 is achieved by generating the desktop 204, the number of background objects, in this example background windows 206, the first intermediate window 208 and the foreground object 210 in the user-interface frame buffer 212. Although represented graphically in FIG. 2, as one would expect from the IPU working in combination with the display device 122, the desktop 204, the number of background windows 206, the first intermediate window 208 and the foreground object 210 reside in the user-interface frame buffer 212 as first image data.

The number of background windows 206 includes a video window 214 associated with a video or media player application, constituting a second intermediate object. A viewfinder applet 215 associated with the video player application also generates, using the GUI, a viewfinder window 216 that constitutes a third intermediate object. In this example, the video player application supports voice and video over Internet Protocol (V2IP) functionality, the video window 214 being used to display first time-varying images of a third party with which a user of the smartphone 100 is communicating. The viewfinder window 216 is provided so that the user can see a field of view of the digital camera unit 115 of the smartphone 100 and hence how images of the user will be presented to the third party during, for example, a video call. The viewfinder window 216 of this example overlies, in part, the video window 214 and the first intermediate window 208, and the foreground object 210 overlies the viewfinder window 216.

In this example, a video decode applet 218 that is part of the video player application is used to generate frames of first video images 220 constituting a video plane, that are stored in a first video plane buffer 222 as second, time-varying, image data, the first video plane buffer 222 constituting a second memory space. Likewise, the viewfinder applet 215 that is also part of the video player application is used to generate frames of second video images 226, constituting a second video plane, which are stored in a second video plane buffer 228, constituting a third memory space, as third, time-varying, image data. In this example, both the second and third, time-varying, image data is refreshed at a rate of 30 fps.

In order to facilitate combination, firstly, of the first video images 220 with the content of the user-interface frame buffer 212 and, secondly, of the second video images 226 with the content of the user-interface frame buffer 212, a masking, or area-reservation, process is employed. In particular, the first video images 220 are to appear in the video window 214, and the second video images are to appear in the viewfinder window 216.

In this example, first keycolour data, constituting first mask data, is used by the GUI to fill a first reserved, or mask, area 230 bounded by the video window 214 where at least part of the first video images 220 is to be located and visible, i.e. the part of the video window 220 that is not obscured by foreground or intermediate windows/objects. Likewise, second keycolour data, constituting second mask data, is used by the GUI to fill a second reserved, or mask, area 232 within the viewfinder window 216 where at least part of the second video images 226 is to be located and shown. The first and second keycolours are colours selected to constitute first and second mask areas to be replaced by the content of the first video plane buffer 222 and the content of the second video plane buffer 228, respectively. However, consistent with the concept of a mask, replacement is to the extent that only parts of the content as defined by the first and second reserved, or mask, areas 230, 232 are taken from the first video plane buffer 222 and the second video plane buffer 228 for combination. Consequently, portions of the first video plane buffer 222 and the second video plane buffer 228 that replace the first and second keycolour data corresponding to the first and second mask areas 230, 232 are defined, when represented graphically, by the pixel coordinates defining the first and second mask areas 230, 232, respectively. In this respect, when the video window 214 is opened by the GUI, the location of the first mask area 230 defined by the pixel coordinates associated therewith and the first keycolour data are communicated to the IPU by the application associated with the first keycolour data, for example the video decode applet 218. Likewise, when the GUI opens the viewfinder window 216, the location of the second mask area 232 defined by the pixel coordinates associated therewith and the second keycolour data are communicated to the IPU by the application associated with the second keycolour data, for example the viewfinder applet 215. Of course, when considered in terms of frame buffers the pixel coordinates are defined by memory or buffer addresses of the video window 214 and the viewfinder window 216.

Use of the keycolours by the IPU to implement the first and second mask areas 230, 232 is achieved, in this example, through use of microcode embedded in the IPU of the i.MX31 processor to support an ability to transfer data from a source memory space to a destination memory space, the source memory space being continuous and the destination memory space being discontinuous. This ability is sometimes known as “2D DMA”, the 2D DMA being capable of implementing an overlay technique that takes into account transparency defined by, for example, either keycolour or alphablending data. This capability is sometimes known as “graphics combine” functionality.

In particular, in this example, the IPU uses the acquired locations of the video window 214 and the viewfinder window 216 to read the user-interface buffer 212 on a pixel-by-pixel basis using a 2D DMA transfer process. If a pixel “read” out of the previously identified video window 214 as used in the 2D DMA transfer process is not of the first keycolour, the pixel is transferred to a main frame buffer 236 constituting a composite memory space. This process is repeated until a pixel of the first keycolour is encountered within the first video window 214, i.e. a pixel of the first mask area 230 is encountered. When a pixel of the first keycolour is encountered in the user-interface buffer 212 corresponding to the interior of the video window 214, the 2D DMA transfer process implemented results in a corresponding pixel from the first video plane buffer 222 being retrieved and transferred to the main frame buffer 236 in place of the keycolour pixel encountered. In this respect, the pixel retrieved from the first video plane buffer 222 corresponds to a same position as the pixel of the first keycolour when represented graphically, i.e. the coordinates of the pixel retrieved from the first video plane buffer 222 corresponds to the coordinates of the keycolour pixel encountered. Hence, a masking operation is achieved. The above masking operation is repeated in respect of the video window 214 for all keycoloured pixels encountered in the user-interface buffer 212 as well as non-keycoloured pixels. This constitutes a first combine step 234. However, when pixels of the second keycolour are encountered in the viewfinder window 216, the 2D DMA transfer process results in access to the second video plane buffer 228, because the second keycolour corresponds to the second mask area 232 in respect of the content of the viewfinder window 216. As in the case of pixels of the first keycolour and the first mask area 230, where a pixel of the second keycolour is encountered within the viewfinder window 216 using the 2D DMA transfer process, a correspondingly located, when represented graphically, pixel from the second video plane buffer 228 is transferred to the main frame buffer 236 in place of the pixel of the second keycolour. Again, the coordinates of the pixel retrieved from the second video plane buffer 222 corresponds to the coordinates of the keycolour pixel encountered. This masking operation is repeated in respect of the viewfinder window 216 for all keycoloured pixels and non-keycoloured pixels encountered in the user-interface buffer 212. This constitutes a second combine step 235. The main frame buffer 236 therefore contains a resultant combination of the user-interface frame buffer 212, the first video plane buffer 222 and the second video plane buffer 228 as constrained by the first and second mask areas 230, 232. The first and second combine steps 234, 235 are, in this example, performed separately, but can be performed substantially contemporaneously for reasons of improved performance. However, separate performance of the first and second combine steps can be advantageous where performance of, for example, the second combine step 235 does not have to be performed as often as, for example, the first combine step 234 due to the frame rate of the second image data 226 being less than the frame rate of the first image data 220.

Thereafter, the content of the main frame buffer 236 is used by the video controller 112 to represent the content of the main frame buffer 236 graphically via the display device 122. Any suitable known technique can be employed. In this example, the suitable technique employs an Asynchronous Display Controller (ADC), but a Synchronous Display Controller (SDC) can be used. In order to mitigate flicker, any suitable double buffer or, using the user-interface frame buffer 212, triple buffer technique known in the art can be employed.

Although the first and second reserved, or mask, areas 230, 232 have been formed in the above-described example using keycolour pixels, the first and/or second reserved, or mask, areas 230, 232 can be identified using local alpha blending or global alpha blending properties of pixels. In this respect, instead of the 2D DMA identifying pixels of one or more mask area using keycolour parameters, an alphablending parameter of each pixel can be analysed to identify pixels defining the one or more reserved areas. For example, a pixel having 100% transparency can be used to signify a pixel of a mask area. The ability to perform DMA based upon alphablending parameters is possible when using the i.MX31 processor.

If desirable, one or more intermediate buffers can be employed to store data temporarily as part of the masking operation. 2D DMA can therefore be performed simply to transfer data to the one or more intermediate buffers, and keycolour and/or alphablending analysis of mask areas can be preformed subsequently. Once masking operations are complete 2D DMA transfer processes can be used again simply to transfer processed image data to the main frame buffer 236.

In order to reduce net processing overhead and hence save power, the first video plane buffer 222 can be monitored in order to detect changes to the first video images 220, any detected change being used to trigger execution of the first combine step 234. The same approach can be taken in relation to changes to the second video plane buffer 228 and execution of the second combine step 235.

It is thus possible to provide image processing apparatus and a method of transferring image data that is not constrained to a maximum number of planes of time-varying image data that can be displayed by a user-interface. Further, a window containing time-varying image data does not have to be uniform, for example a quadrilateral, and can possess non-right angled sides, for example a curved side, when overlapping another window. Additionally, relative positions of windows (and their contents), when represented graphically, are preserved and blocks of image data associated with different refresh rates can be represented contemporaneously. The method can be implemented exclusively in hardware, if desired. Hence, software process serialisation can be avoided and no specific synchronisation has to be performed by software.

The method and apparatus are neither operating system nor user-interface specific. Likewise, the display device type is independent of the method and apparatus. The use of additional buffers to store mask data is not required. Likewise, intermediate time-varying data, for example video, buffers are not required. Furthermore, due to the ability to implement the method in hardware, the MIPS overhead and hence power consumption required to combine the time-varying image data with the user-interface is reduced. Indeed, only the main frame buffer has to be refreshed without generation of multiple foreground, intermediate and background planes. The refresh of the user-interface buffer does not impact upon the relative positioning of the windows. Of course, the above advantages are exemplary, and these or other advantages may be achieved by the invention. Further, the skilled person will appreciate that not all advantages stated above are necessarily achieved by embodiments described herein.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of transferring image data to a composite memory space for output by a display device, the method comprising:
providing first image data in a first memory space, the first image data having a first frame rate associated therewith;
incorporating mask data into the first image data, the mask data defining a reserved output area;
transferring at least part of the first image data and at least part of second image data to the composite memory space, the second image data residing in a second memory space and having a second frame rate associated therewith;
wherein the mask data is used by a masking process in relation to the second image data in order to provide the at least part of the second image data substantially in place of the mask data such that, when output, the at least part of the second image data occupies the reserved output area.

2. A method as claimed in claim 1, wherein the composite memory space is a main frame buffer for the display device.

3. A method as claimed in claim 1, wherein the first image data constitutes a presentation plane.

4. A method as claimed in claim 1, wherein the first image data corresponds to a graphical user interface.

5. A method as claimed in claim 1, wherein the first image data defines, when output, a plurality of display objects.

6.-13. (canceled)

14. A method as claimed in claim 1, wherein the first memory space is a first frame buffer and/or the second memory space is a second frame buffer.

15. A method as claimed in claim 1, wherein the first frame rate is different from the second frame rate.

16.-19. (canceled)

20. A method as claimed in claim 1, wherein the at least part of the second image data is, when output, disposed amongst the output of the first image data.

21. A method as claimed in claim 1, wherein the mask data defines a display location amongst the first image data, when output.

22. A method as claimed in claim 1, wherein the mask data is used to by the masking process in relation to the second image data so that the at least part of the second image data is selected when transferred to the composite memory space.

23.-29. (canceled)

30. A method as claimed in claim 1, further comprising:
employing a DMA transfer process to provide the masking process in relation to the second image data and transfer the at least part of the second image data to the composite memory space.

31. A method as claimed in claim 1, further comprising the step of:
monitoring the at least part of the second image data; and wherein
the at least part of the second image data is provided substantially in place of the mask data in response to detection of a change in the at least part of the second image data.

32. A computer program product including code portions for performing, when run on a programmable apparatus, operations for transferring image data to a composite memory space for output by a display device, the operations comprising:
providing first image data in a first memory space, the first image data having a first frame rate associated therewith;
incorporating mask data into the first image data, the mask data defining a reserved output area;
transferring at least part of the first image data and at least part of second image data to the composite memory space, the second image data residing in a second memory space and having a second frame rate associated therewith;
wherein the mask data is used by a masking process in relation to the second image data in order to provide the at least part of the second image data substantially in place of the mask data such that, when output, the at least part of the second image data occupies the reserved output area.

33. An image processing apparatus, the apparatus comprising:
a processing resource arranged to transfer, when in use, image data to a composite buffer for output by a display device;
a first buffer comprising, when in use, first image data, the first image data having a first frame rate associated therewith;
wherein the processing resource supports a masking process and is arranged to incorporate mask data into the first image data, the mask data defining a reserved output area; and
wherein the processing resource supports data transfer and is arranged to transfer at least part of the first image data and at least part of second image data to the composite buffer, the second image data residing in a second buffer and having a second frame rate associated therewith;
wherein the mask data is used by the masking process in relation to the second image data in order to provide the at least part of the second image data substantially in place of the mask data such that, when output, the at least part of the second image data occupies the reserved output area.

34. A method as claimed in claim 2, wherein the first image data constitutes a presentation plane.

35. A method as claimed in claim 2, wherein the first frame rate is different from the second frame rate.

36. A method as claimed in claim 15, wherein the at least part of the second image data is, when output, disposed amongst the output of the first image data.

37. A method as claimed in claim 21, wherein the mask data is used to by the masking process in relation to the second image data so that the at least part of the second image data is selected when transferred to the composite memory space.

38. A method as claimed in claim 3, further comprising:
employing a DMA transfer process to provide the masking process in relation to the second image data and transfer the at least part of the second image data to the composite memory space.

39. A method as claimed in claim 15, further comprising the step of:
monitoring the at least part of the second image data; and wherein
the at least part of the second image data is provided substantially in place of the mask data in response to detection of a change in the at least part of the second image data.
